(19) United States
(12) Patent Application Publication
(10) Pub. No.: US 2018/0065422 A1
(43) Pub. Date: Mar. 8, 2018

(54) PNEUMATIC TIRE

(71) Applicant: TOYO TIRE & RUBBER CO., LTD., Osaka (JP)

(72) Inventor: Shingo Kuwano, Osaka-shi (JP)

(73) Assignee: TOYO TIRE & RUBBER CO., LTD., Osaka (JP)

(21) Appl. No.: 15/496,316

(22) Filed: Apr. 25, 2017

(30) Foreign Application Priority Data
Sep. 7, 2016 (JP) 2016-174740

(51) Int. Cl. B60C 13/02; B60C 11/01

(52) U.S. Cl. CPC B60C 13/02; B60C 11/01

(57) ABSTRACT

In a pneumatic tire, a sidewall portion includes a plurality of projecting portions projecting in a tire width-direction. The projecting portions are placed such that at least portions of the projecting portions are superposed on a first block in a tire radial-direction as viewed in the tire width-direction. At least one of the projecting portions includes an opening. The opening is placed in a portion of the projecting portion which most projects in the tire width-direction.

### CROSS REFERENCE TO RELATED APPLICATIONS

This application claims the benefit of priority of Japanese application no. 2016-174740, filed on Sep. 7, 2016, which is incorporated herein by reference.

### BACKGROUND OF THE INVENTION

### Field of the Invention

The present invention relates to a pneumatic tire having a plurality of projecting portions which project in a tire width-direction.

### Description of the Related Art

There are conventionally known pneumatic tires each having a plurality of projecting portions which project in a tire width-direction (e.g., JP-A-2010-264962). According to a structure of this pneumatic tire, traction performance on a mud area or a rocky area is enhanced due to resistance caused when the projecting portions shear dirt and due to friction between the projecting portions and rock, and resistance to external damage is enhanced due to increase in rubber thickness.

By the way, weight balance of the tire is prone to become uneven due to existence of the projecting portions. Accordingly, when the tire is produced (vulcanized), rubber does not smoothly flow, the tire may be chipped (bare may be generated) with respect to a desired tire shape, or uniformity may be lowered and this may cause vibration or noise of a vehicle.

### SUMMARY OF INVENTION

It is an object of the present invention to provide a pneumatic tire capable of suppressing unevenness of weight balance.

There is provided a pneumatic tire, which includes:

a sidewall portion extending in a tire radial-direction; and

a tread portion having a tread surface on outer side in the tire radial-direction and connected to an outer end of the sidewall portion in the tire radial-direction, wherein

the tread portion includes a plurality of grooves extending to an outer end in a tire width-direction, and a plurality of blocks arranged in a tire circumferential-direction by being defined the blocks by the plurality of grooves,

the plurality of blocks includes a plurality of first blocks and a plurality of second blocks, outer end edges of the second blocks on the tread surface in the tire width-direction being located on an inner side in the tire width-direction than outer end edges of the first blocks on the tread surface in the tire width-direction due to recesses provided at outer ends of the second blocks in the tire width-direction,

the sidewall portion includes a plurality of projecting portions projecting in the tire width-direction,

the projecting portions are placed such that at least portions of the projecting portions are superposed on the first block in the tire radial-direction as viewed in the tire width-direction,

at least one of the projecting portions includes an opening, and

the opening is placed in a portion of the projecting portion which most projects in the tire width-direction.

Also, the pneumatic tire may have a configuration in which:

an outer end edge of the opening in the tire radial-direction is located on the outer side in the tire radial-direction than an inner end edge of the recess in the tire radial-direction.

Also, the pneumatic tire may have a configuration in which:

the opening is separated from both end edges of the projecting portions in the tire radial-direction and the tire circumferential-direction.

Also, the pneumatic tire may have a configuration in which:

the plurality of projecting portions includes a plurality of first projecting portions, at least portions of the first projecting portions are superposed on the first block in the tire radial-direction as viewed in the tire width-direction, and the plurality of projecting portions also include a plurality of second projecting portions, and at least portions of the second projecting portions are superposed on the second block in the tire radial-direction as viewed in the tire width-direction.

Also, the pneumatic tire may have a configuration in which:

a projecting amount of the first projecting portion in the tire width-direction is larger than a projecting amount of the second projecting portion in the tire width-direction, and

the opening is provided only in the first projecting portion.

Also, the pneumatic tire may have a configuration in which:

an apparent volume of the first projecting portion is larger than an apparent volume of the second projecting portion, and

the opening is provided only in the first projecting portion.

Also, the pneumatic tire may have a configuration in which:

a maximum projecting amount of the first projecting portion in the tire width-direction is in a range of 120% to 750% of a maximum projecting amount of the second projecting portion in the tire width-direction.

Also, the pneumatic tire may have a configuration in which:

a maximum projecting amount of the first projecting portion in the tire width-direction is in a range of 120% to 250% of a maximum projecting amount of the second projecting portion in the tire width-direction.

Also, the pneumatic tire may have a configuration in which:

a maximum projecting amount of the first projecting portion in the tire width-direction is in a range of 5 mm to 15 mm, and

a maximum projecting amount of the second projecting portion in the tire width-direction is in a range of 2 mm to 12 mm.

Also, the pneumatic tire may have a configuration in which:

a maximum projecting amount of the first projecting portion in the tire width-direction is in a range of 8 mm to 12 mm, and

a maximum projecting amount of the second projecting portion in the tire width-direction is in a range of 5 mm to 9 mm.

Also, the pneumatic tire may have a configuration in which:

an outer end of the first projecting portion in the tire radial-direction is located on an inner side in the tire radial-direction than the tread surface of the first block.

Also, the pneumatic tire may have a configuration in which:

an outer end of the second projecting portion in the tire radial-direction is located at the same position as a bottom surface of the recess of the second block in the tire radial-direction.

Also, the pneumatic tire may have a configuration in which:

the first blocks and the second blocks are alternately placed in the tire circumferential-direction.

Also, the pneumatic tire may have a configuration in which:

at least one of the projecting portions includes the two openings,

the sidewall portion includes an annular protrusion portion projecting in the tire width-direction and extending along the tire circumferential-direction,

the first opening is placed on an inner side in the tire radial-direction than the annular protrusion portion, and

the second opening is placed on an outer side in the tire radial-direction than the annular protrusion portion.

Also, the pneumatic tire may have a configuration in which:

the projecting portion is placed such that 25% or more of the projecting portion in the tire circumferential-direction is superposed on the first block in the tire radial-direction as viewed in the tire width-direction.

Also, the pneumatic tire may have a configuration in which:

a width size between an opening edge of the opening and an end edge of the projecting portion is 1.5 mm or more.

Also, the pneumatic tire may have a configuration in which:

a center position of the opening in the tire circumferential-direction matches with a center position of the projecting portion in the tire circumferential-direction.

### BRIEF DESCRIPTION OF THE DRAWINGS

FIG. 1 is a sectional view of essential portions in a tire meridional surface of a pneumatic tire according to an embodiment;

FIG. 2 is a perspective view of essential portions of the pneumatic tire of the embodiment;

FIG. 3 is a side view of essential portions (perspective view in tire width-direction) of the pneumatic tire of the embodiment;

FIG. 4 is an enlarged sectional view of essential portions taken along line IV-IV in FIG. 3;

FIG. 5 is an enlarged sectional view of essential portions taken along line V-V in FIG. 3; and

FIG. 6 is a sectional view of essential portions showing an end edge of the pneumatic tire of the embodiment.

### DETAILED DESCRIPTION OF THE PREFERRED EMBODIMENTS

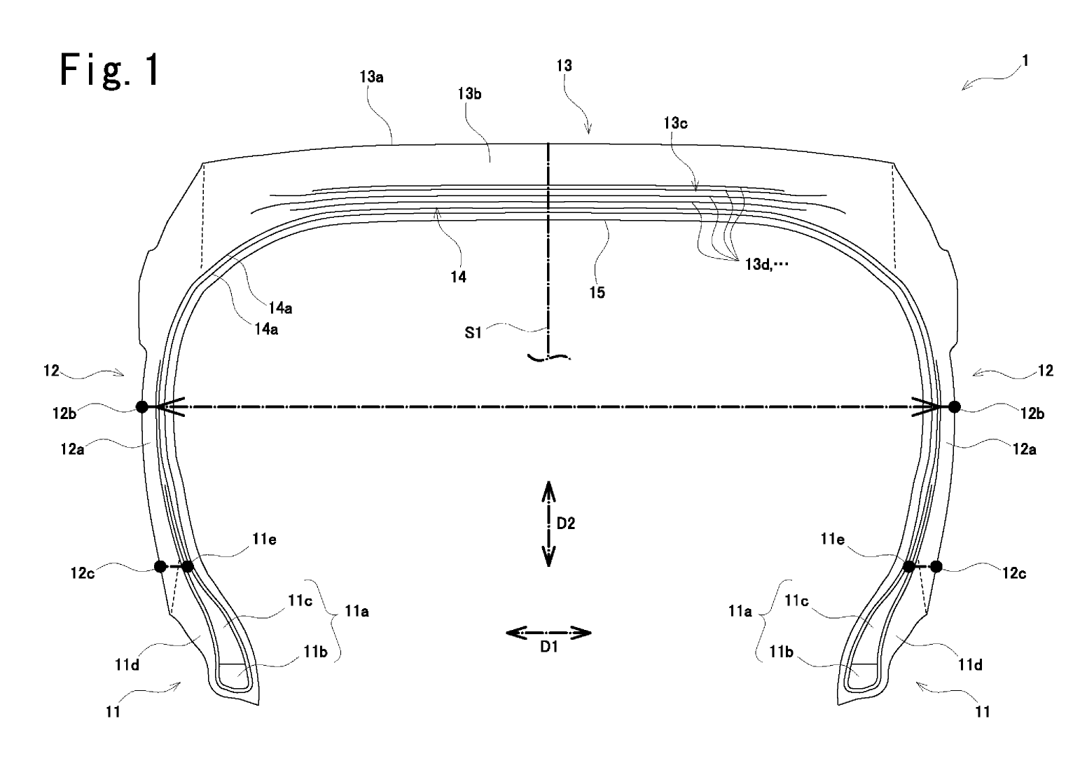

An embodiment of a pneumatic tire will be described below with reference to FIGS. 1 to 6. Size ratios in each of the drawings do not always match with actual size ratios, and size ratios between the drawings do not always math with each other.

As shown in FIG. 1, the pneumatic tire (also called “tire” simply) 1 includes a pair of bead portions 11 having beads 11a. The tire 1 includes sidewall portions 12 extending from the bead portions 11 radially outward in a tire radial-direction D2, and a tread portion 13 which is connected to outer ends of the pair of sidewall portions 12 in the tire-radial direction D2. The tread portion 13 is provided with a tread surface 13a which comes into contact with ground. The tread surface 13a is located on the outer side of in a tire radial-direction D2. The tire 1 is mounted on a rim (not shown).

The tire 1 includes a carcass layer 14 extending between the pair of beads 11a and 11a, and an inner linear 15 located on an inner side of the carcass layer 14 and facing an inner space of the tire 1 into which air is charged. The carcass layer 14 and the inner linear 15 are placed along an inner periphery of the tire over the bead portions 11, the sidewall portions 12 and the tread portion 13.

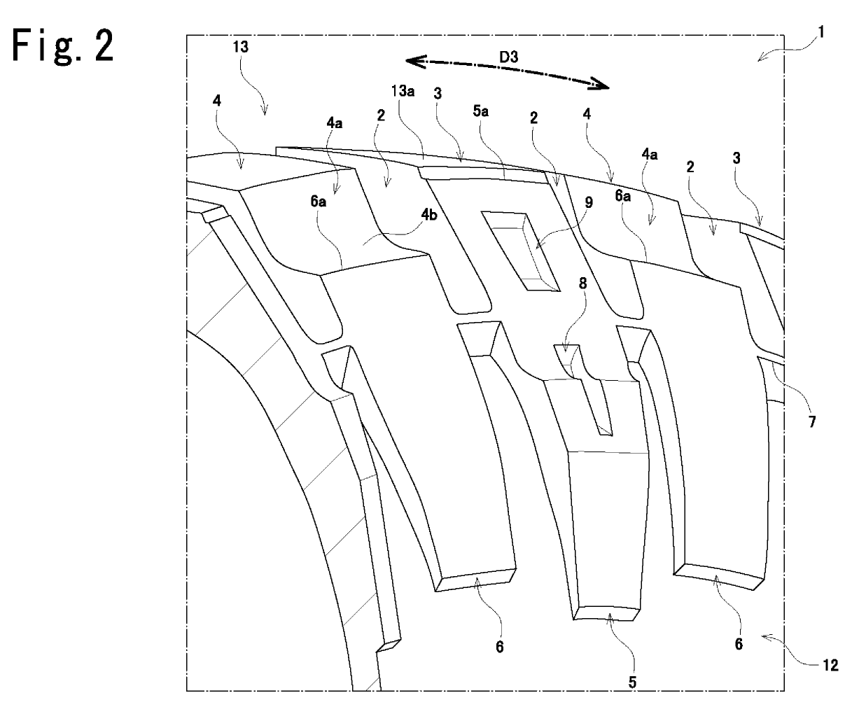

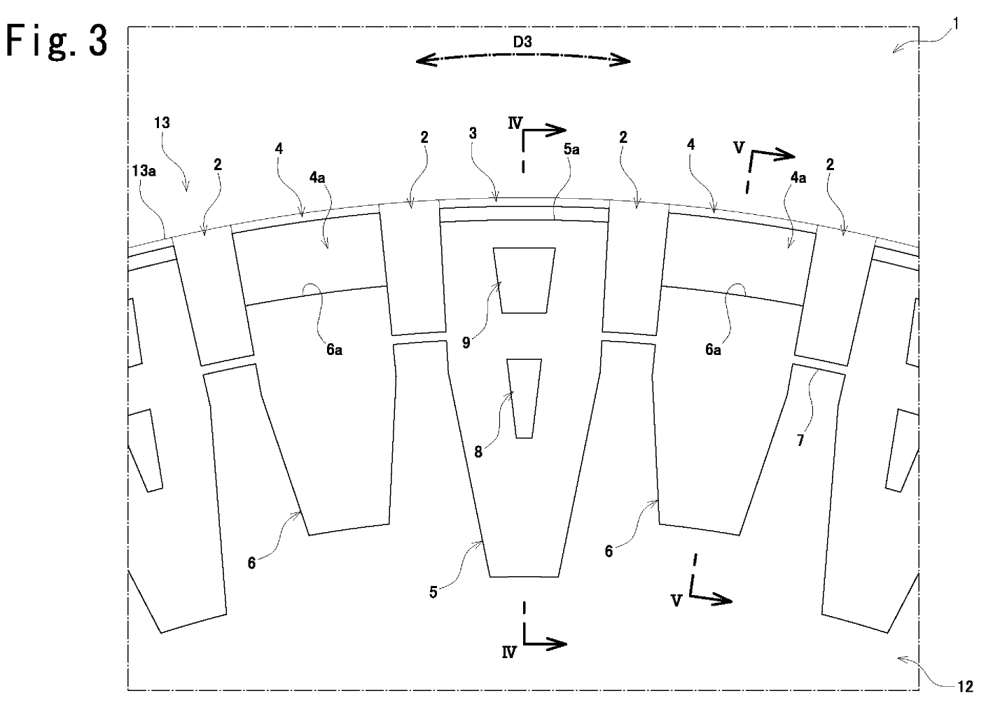

In FIG. 1 (also in the other drawings), a first direction D1 is a tire width-direction D1 which is parallel to the tire rotation axis, a second direction D2 is the tire radial-direction D2 which is a diameter direction of the tire 1, and a third direction D3 (see FIGS. 2 and 3, for example) is a tire circumferential-direction D3 which is a direction around a tire axial-direction. A tire equator surface S1 is a surface intersecting with the tire rotation axis at right angle, and is located on a center of the tire width-direction D1, and a tire meridional surface is a surface including a surface including the tire rotation axis, and intersecting with the tire equator surface S1.

Each of the beads 11a includes an annularly formed bead core 11b, and a bead filler 11c placed on an outer side of the bead core 11b in the tire radial-direction D2. For example, the bead core 11b is formed by laminating rubber-coated bead wires (metal wires, for example), and the bead filler 11c is formed by forming hard rubber outward of the tire radial-direction D2 in a tapered manner.

Each of the bead portions 11 includes a rim strip rubber 11d placed on an outer side in the tire width-direction D1 than the carcass layer 14 to configure an outer surface which comes into contact with the rim. Each of the sidewall portions 12 includes a sidewall rubber 12a which is placed on an outer side in the tire width-direction D1 than the carcass layer 14 to configure an outer surface.

The tread portion 13 includes a tread rubber 13b. An outer surface of the tread rubber 13b configures the tread surface 13a. The tread portion 13 also includes a belt portion 13c placed between the tread rubber 13b and the carcass layer 14. The belt portion 13c includes a plurality of (four in FIG. 1) belt plies 13d. For example, each of the belt plies 13d includes a plurality of belt cords (organic fiber or metal, for example) which are arranged in parallel, and topping rubbers for coating the belt cords.

The carcass layer 14 is composed of at least one (two in FIG. 1) carcass plies 14a. Each of the carcass plies 14a is folded back around the bead 11a to surround the bead 11a. Each of the carcass plies 14a includes a plurality of ply cords (organic fiber or metal, for example) which are arranged in a direction intersecting with the tire circumferential-direction D3 substantially at right angles, and topping rubbers for coating the ply cords.

To maintain the air pressure, the inner linear 15 has an excellent function to prevent gas from passing through the inner linear 15. In the sidewall portion 12, the inner linear 15 is in intimate contact with an inner periphery of the carcass layer 14, and no other material is interposed between the inner linear 15 and the carcass layer 14.

For example, in a distance between the carcass ply 14a which is placed on the innermost side and a tire inner peripheral surface (inner peripheral surface of inner linear 15), the distance of the sidewall portion 12 is 90% to 180% of the distance of the tread portion 13. More specifically, the distance of the sidewall portion 12 is 120% to 160% of the distance of the tread portion 13.

An outer surface of the sidewall portion 12 has a position 12b which becomes the same, in the tire radial-direction D2, as the tire maximum position (more specifically, maximum distance position of distance of carcass layer 14 between outer sides in tire width-direction D1). The position 12b is called a tire maximum width position 12b, hereinafter.

The outer surface of the sidewall portions 12 has a position 12c which becomes the same, in the tire radial-direction D2, as an outer end Ile of the bead filler 11c in the tire radial-direction D2. The position 12c is called a bead filler outer end position 12c, hereinafter.

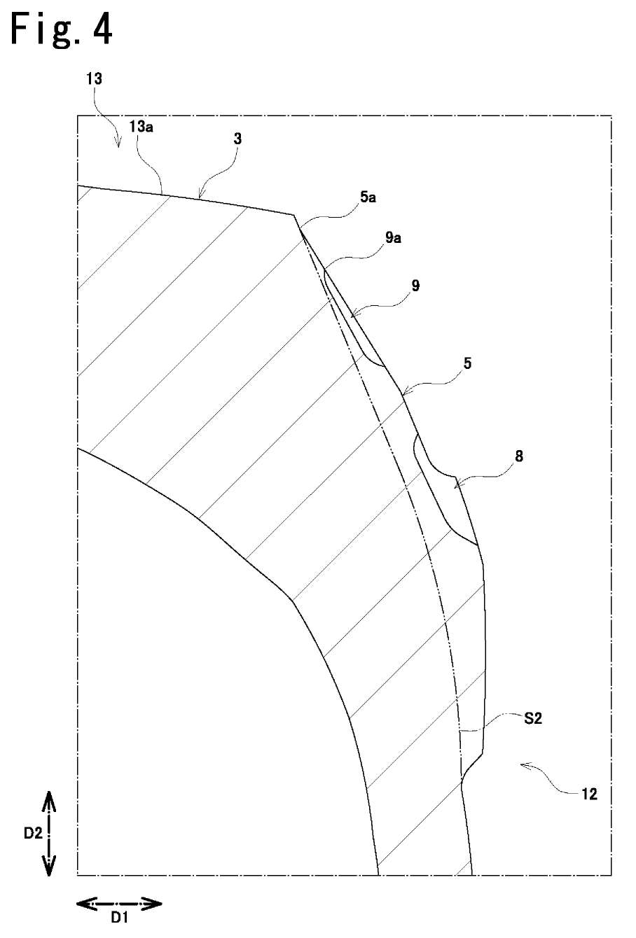

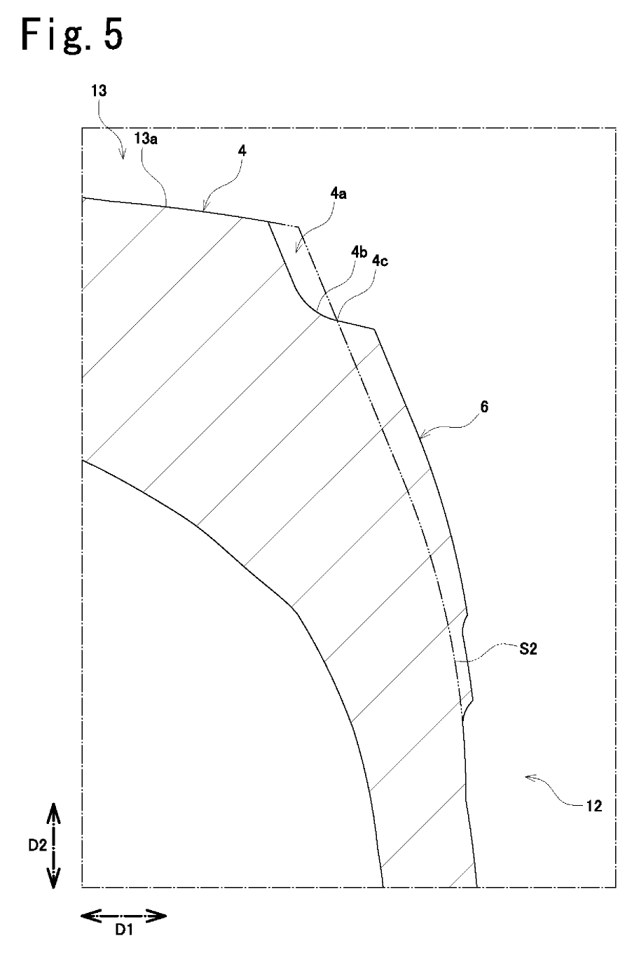

As shown in FIGS. 2 to 5, the tread portion 13 includes a plurality of grooves 2 extending outer end in the tire width-direction D1, and a plurality of blocks 3 and 4 which are defined by the plurality of groves 2 and arranged in the tire circumferential-direction D3. In FIGS. 4 and 5, dashed-two dotted lines show profile surfaces (reference surfaces) S2 of the tire 1.

The plurality of blocks 3 and 4 include a plurality of first blocks 3 and a plurality of second blocks 4 having recesses 4a, which are recesses with respect to a profile surface S2, at an outer end in the tire width-direction D1. An outer end edge of the second block 4 on the tread surface 13a in the tire width-direction D1 is located on an inner side in the tire width-direction D1 than the outer end edge of the first block 3 on the tread surface 13a in the tire width-direction D1. Accordingly, the outer end edge of the tread surface 13a in the tire width-direction D1 is formed uneven as viewed in the tire radial-direction D2.

Since the uneven shapes exist, components of the surfaces and the edges are formed. Since the uneven shapes are formed on the portions of the tire which come into contact with dirt, sand and rock, areas which come into contact with the dirt, sand and rock become large, and surfaces and edges formed by the uneven shapes easily come into contact with the dirt, sand and rock of various positions. Since the uneven shapes are formed in the portions which come into contact with the dirt, sand and rock, traction performance is enhanced.

In the embodiment, the first blocks 3 and the second blocks 4 are placed alternately in the tire circumferential-direction D3. That is, blocks which are adjacent with the first blocks 3 in the tire circumferential-direction D3 are the second blocks 4, and blocks which are adjacent with the second blocks 4 in the tire circumferential-direction D3 are the first blocks 3.

The sidewall portion 12 includes a plurality of projecting portions 5 and 6 which project from the profile surface S2 in the tire width-direction D1. The sidewall portion 12 includes an annular protrusion portion 7 which projects from the profile surface S2 in the tire width-direction D1 and extends along the tire circumferential-direction D3.

The projecting portions 5 and 6 are placed outward of the sidewall portion 12 at least in the tire radial-direction D2. Accordingly, the projecting portions 5 and 6 can come into contact with mud and sand in a state where the tire 1 sinks due to a weight of the vehicle in a mud area and a sand area, and can also come into contact with the uneven rocks in a rocky area. That is, the projecting portions 5 and 6 come into contact with the ground in bad roads such as a mud area, a sand area and a rocky area. The projecting portions 5 and 6 do not normally come into contact with the ground in a flat road.

The projecting portions 5 and 6 are located on an outer side in the tire radial-direction D2 than the bead filler outer end position 12c (see FIG. 1) of the sidewall portion 12. More specifically, the projecting portions 5 and 6 are placed on the outer side in the tire radial-direction D2 than the tire maximum width position 12b (see FIG. 1) of the sidewall portion 12.

As shown in FIG. 3, the plurality of projecting portions 5 and 6 include a plurality of first projecting portions 5. At least portions of the first projecting portions 5 are interposed on the first block 3 in the tire radial-direction D2 as viewed in the tire width-direction D1. The projecting portions 5 and 6 also include a plurality of second projecting portions 6. At least portions of the second projecting portions 6 are interposed on the second block 4 in the tire radial-direction D2. For example, the projecting portions 5 and 6 are superposed on the blocks 3 and 4 by 25% or more in the tire circumferential-direction D3 (preferably 50% or more, and more preferably 75% or more) as viewed in the tire width-direction D1.

As viewed in the tire width-direction D1, the first projecting portions 5 are superposed only on the first blocks 3 in the tire radial-direction D2, and the second projecting portions 6 are superposed only on the second blocks 4 in the tire radial-direction D2. That is, the projecting portions 5 and 6 are superposed only on one of the blocks 3 and 4 in the tire radial-direction D2 as viewed in the tire width-direction D1.

The first projecting portions 5 and the second projecting portions 6 are separated from each other in the tire circumferential-direction D3. In the embodiment, the first projecting portions 5 and the second projecting portions 6 are alternately placed in the tire circumferential-direction D3. That is, a projecting portion which is adjacent with the first projecting portion 5 in the tire circumferential-direction D3 is the second projecting portion 6, and a projecting portion which is adjacent with the second projecting portion 6 in the tire circumferential-direction D3 is the first projecting portion 5.

An outer end 5a of the first projecting portion 5 in the tire radial-direction D2 is located on an inner side in the tire radial-direction D2 than the tread surface 13a of the first block 3. Accordingly, uneven shapes are formed by the tread surface 13a of the first block 3 and the outer end 5a of the first projecting portion 5 in the tire radial-direction D2. Therefore, traction performance can be enhanced.

An outer end 6a of the second projecting portion 6 in the tire radial-direction D2 is located at the same position as a bottom surface 4b of the recess 4a of the second block 4 in the tire radial-direction D2. Accordingly, a surface which is recessed from the tread surface 13a of the second block 4 (surface configured by the bottom surface 4b of the recess 4a and the outer end 6a of the second projecting portion 6) becomes large. Therefore, traction performance can be enhanced.

Each of the first projecting portions 5 includes openings 8 and 9. Accordingly, a weight is increased due to existence of the first projecting portion 5, and weights of the openings 8 and 9 are prevented from increasing. Therefore, weight balance which may be caused by the existence of the first projecting portion 5 is restrained from becoming uninform. Due to the existence of the openings 8 and 9, components of the surfaces and the edges increase, and thus traction performance is enhanced.

The openings 8 and 9 are separated from both end edges of the first projecting portion 5 in the tire radial-direction D2. Further, the openings 8 and 9 are separated from the both end edges of the first projecting portion 5 in the tire circumferential-direction D3. Accordingly, since rigidity around the openings 8 and 9 of the first projecting portion 5 can be enhanced, traction performance by the first projecting portion 5 can be maintained. For example, a distance between the opening edges of the openings 8 and 9 and the end edge of the first projecting portion 5 is 1.5 mm or more (preferably, 2.0 mm or more).

Center positions of the openings 8 and 9 in the tire circumferential-direction D3 match with center positions of the first projecting portions 5 in the tire circumferential-direction D3. The openings 8 and 9 are line-symmetric with respect to the center of the first projecting portion 5 in the tire circumferential-direction D3.

Each of the first projecting portions 5 includes the two openings 8 and 9. More specifically, the first projecting portion 5 includes the first opening 8 located on an inner side in the tire radial-direction D2, and the second opening 9 located on the outer side in the tire radial-direction D2. The first opening 8 is located on the inner side in the tire radial-direction D2 than the annular protrusion portion 7, and the second opening 9 is located on the outer side in the tire radial-direction D2 than the annular protrusion portion 7.

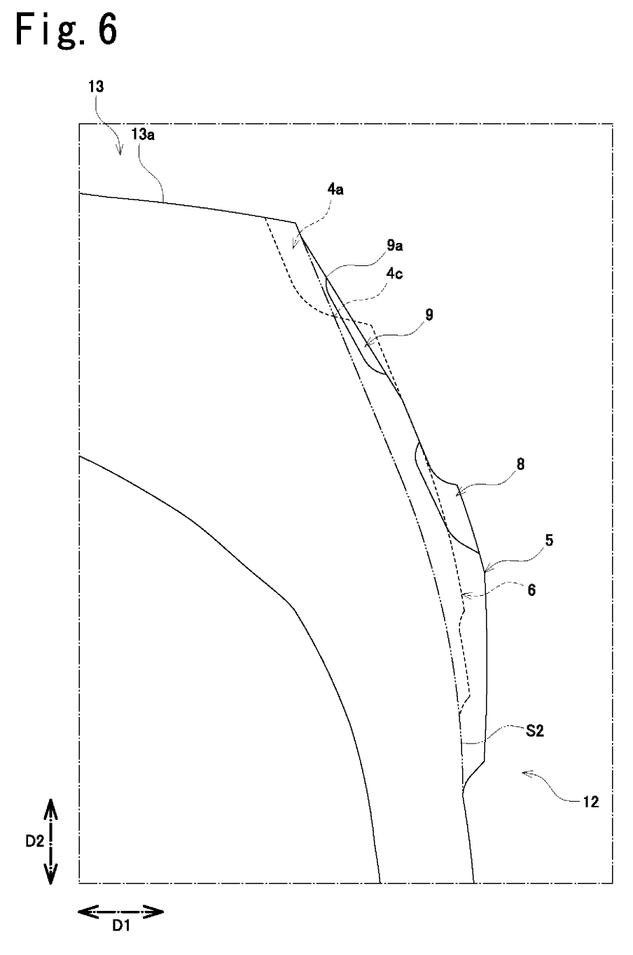

FIGS. 4 and 5 are shown in a combined manner in FIG. 6. Solid lines show end edges of the first block 3 and the first projecting portion 5, broken lines show end edges of the second block 4 and the second projecting portion 6, and dashed-two dotted lines show the profile surface S2. That is, in FIG. 6, the first block 3 and the first projecting portion 5, as well as the second block 4 and the second projecting portion 6 are superposed in the tire circumferential-direction D3.

As shown in FIG. 6, a projecting amount (maximum projecting amount) of the first projecting portion 5 in the tire width-direction D1 is larger than a projecting amount (maximum projecting amount) of the second projecting portion 6 in the tire width-direction D1. On the other hand, the openings 8 and 9 are formed only in the first projecting portion 5 and are not formed in the second projecting portion 6. Therefore, it is possible to suppress the unevenness of the weight balance which may be caused by a difference between the projecting amounts of the first projecting portion 5 and the second projecting portion 6.

For example, the maximum projecting amount of the first projecting portion 5 in the tire width-direction D1 is in a range of 120% to 750% of the maximum projecting amount of the second projecting portion 6 in the tire width-direction D1 and is more specifically, 120% to 250%. The maximum projecting amount of the first projecting portion 5 in the tire width-direction D1 is in a range of 5 mm to 15 mm and more specifically, 8 mm to 12 mm. The maximum projecting amount of the second projecting portion 6 in the tire width-direction D1 is in a range of 2 mm to 12 mm and more specifically, 5 mm to 9 mm. In the embodiment, the maximum projecting amount of the first projecting portion 5 in the tire width-direction D1 is 8 mm, and the maximum projecting amount of the second projecting portion 6 in the tire width-direction D1 is 5 mm.

An apparent volume (volume including the openings 8 and 9) of the first projecting portion 5 is larger than an apparent volume of the second projecting portion 6. An actual volume (volume not including the openings 8 and 9) of the first projecting portion 5 is also larger than an actual volume of the second projecting portion 6. In this embodiment, the apparent volume of the second projecting portion 6 is the same as the actual volume of the second projecting portion 6.

The first opening 8 is located at a position of a portion of the first projecting portion 5 which most projects in the tire width-direction D1. Accordingly, the first opening 8 is provided at a portion of the first projecting portion 5 which has the largest volume. Therefore, it is possible to suppress the unevenness of the weight balance which may be caused by the existence of the first projecting portion 5.

An outer end edge 9a of the second opening 9 in the tire radial-direction D2 is located on the outer side in the tire radial-direction D2 than an inner end edge 4c of the recess 4a of the second block 4 in the tire radial-direction D2. Accordingly, in the tire radial-direction D2, a range where the second opening 9 is placed and a range where the recess 4a of the second block 4 is placed are partially superposed on each other. Therefore, it is possible to suppress the unevenness of the weight balance which may be caused by the existence of the first projecting portion 5.

As described above, the pneumatic tire 1 of the embodiment include a sidewall portion 12 extending in a tire radial-direction D2, and a tread portion 13 having a tread surface 13a on outer side in the tire radial-direction D2 and connected to an outer end of the sidewall portion 12 in the tire radial-direction D2. The tread portion 13 includes a plurality of grooves 2 extending to an outer end in a tire width-direction D1, and a plurality of blocks 3 and 4 arranged in a tire circumferential-direction D3 by being defined the blocks 3 and 4 by the plurality of grooves 2. The plurality of blocks 3 and 4 includes a plurality of first blocks 3 and a plurality of second blocks 4, outer end edges of the second blocks 4 on the tread surface 13a in the tire width-direction D1 being located on an inner side in the tire width-direction D1 than outer end edges of the first blocks 3 on the tread surface 13a in the tire width-direction D1 due to recesses 4a provided at outer ends of the second blocks 4 in the tire width-direction D1. The sidewall portion 12 includes a plurality of projecting portions 5 projecting in the tire width-direction D1. The projecting portions 5 are placed such that at least portions of the projecting portions 5 are superposed on the first block 3 in the tire radial-direction D2 as viewed in the tire width-direction D1. At least one of the projecting portions 5 includes an opening 8. The opening 8 is placed in a portion of the projecting portion 5 which most projects in the tire width-direction D1.

According to the above-described configuration, since the outer end of the second block 4 includes the recess 4a in the outer tire width-direction D1, the outer end edge of the tread surface 13a of the second block 4 in the tire width-direction D1 is located on the inner side in the tire width-direction D1 than that of the first block 3 in the tire width-direction D1. Therefore, since positions of the outer end edges of the first block 3 and the second block 4 are different from each other, the uneven shape exhibits the traction performance.

The outer end of the second block 4 in the tire width-direction D1 has the recess 4a. Accordingly, at the position of the second block 4, the traction performance is exhibited by the uneven shape of the second block 4 itself.

At the position of the first block 3, the projecting portion 5 is at least partially superposed on the first block 3 in the tire radial-direction D2 as viewed in the tire width-direction D1. Therefore, the traction performance is exhibited by a positional relation (uneven shape, for example) of the first block 3 and the projecting portion 5.

Due to the existence of the projecting portion 5, the rubber weight of that portion becomes large. Hence, at least one of the projecting portions 5 includes the openings 8 and 9. Accordingly, it is possible to suppress the unevenness of the weight balance which may be caused by the existence of the projecting portion 5. Further, traction performance is exhibited by the surfaces and the edges of the openings 8 and 9.

Further, since the opening 8 is placed at a position of the projecting portion 5 which most projects in the tire width-direction D1, the opening 8 is placed at a portion of the projecting portion 5 where its volume increases. Accordingly, it is possible to further suppress the unevenness of the weight balance which may be caused by the existence of the projecting portion 5.

In the pneumatic tire 1 of the embodiment, an outer end edge 9a of the opening 9 in the tire radial-direction D2 is located on the outer side in the tire radial-direction D2 than an inner end edge 4c of the recess 4a in the tire radial-direction D2.

According to the above-described configuration, since the outer end edge 9a of the opening 9 in the tire radial-direction D2 is located on the outer side in the tire radial-direction D2 than the inner end edge 4c of the recess 4a in the tire radial-direction D2, the range where the opening 9 is placed and the range where the recess 4a is placed are partially superposed on each other. Therefore, it is possible to effectively suppress the unevenness of the weight balance which may be caused by the existence of the first projecting portion 5.

In the pneumatic tire 1 of the embodiment, the openings 8 and 9 are separated from both end edges of the projecting portion 5 in the tire radial-direction D2 and the tire circumferential-direction D3.

According to the above-described configuration, the openings 8 and 9 are separated from both end edges of the projecting portion 5 in the tire radial-direction D2 and the tire circumferential-direction D3. Accordingly, as compared with a configuration in which the opening opens in the tire radial-direction D2 and/or the tire circumferential-direction D3, rigidity of the projecting portion 5 around the openings 8 and 9 can be enhanced. Therefore, it is possible to maintain the traction performance by the projecting portion 5.

In the pneumatic tire 1 of the embodiment, the plurality of projecting portions 5 and 6 include a plurality of first projecting portions 5, at least portions of the first projecting portions 5 are superposed on the first block 3 in the tire radial-direction D2 as viewed in the tire width-direction D1, and the plurality of projecting portions 5 and 6 also include a plurality of second projecting portions 6, and at least portions of the second projecting portions 6 are superposed on the second block 4 in the tire radial-direction D2 as viewed in the tire width-direction D1.

According to the above-described configuration, the tire includes not only the plurality of first projecting portions 5 which are at least partially superposed on the first block 3 in the tire radial-direction D2 as viewed in the tire width-direction D1, but also the plurality of second projecting portions 6 which are at least partially superposed on the second block 4 in the tire radial-direction D2 as viewed in the tire width-direction D1. Accordingly, it is possible to effectively suppress the unevenness of the weight balance which may be caused by the existence of the first projecting portion 5. Further, the traction performance is exhibited not only by the positional relation (uneven shape, for example) between the first projecting portion 5 and the first block 3 in the tire width-direction D1, but also by the positional relation (uneven shape, for example) between the second projecting portion 6 and the second block 4.

In the pneumatic tire 1 of the embodiment, a projecting amount of the first projecting portion 5 in the tire width-direction D1 is larger than a projecting amount of the second projecting portion 6 in the tire width-direction D1. And the openings 8 and 9 are provided only in the first projecting portion 5.

According to the above-described configuration, the outer end edge of the first block 3 on the tread surface 13a in the tire width-direction D1 is located on the outer side in the tire width-direction D1 than that of the second block 4, but the projecting amount of the first projecting portion 5 in the tire width-direction D1 is larger than that of the second projecting portion 6 in the tire width-direction D1. Accordingly, the traction performance by the positional relation (uneven shape, for example) of the projecting portions 5 and 6 and the blocks 3 and 4 in the tire width-direction D1 is effectively exhibited.

Further, since the projecting amounts of the first projecting portion 5 and the second projecting portion 6 are different from each other, the traction performance is exhibited by the positional relation (uneven shape, for example) of the first projecting portion 5 and the second projecting portion 6 in the tire width-direction D1. Further, the openings 8 and 9 are provided only in the first projecting portion 5 having the large projecting amount in the tire width-direction D1. Accordingly, it is possible to effectively suppress the unevenness of the weight balance which may be caused by the difference of the projecting amounts of the first projecting portion 5 and the second projecting portion 6.

In the pneumatic tire 1 of the embodiment, an apparent volume of the first projecting portion 5 is larger than an apparent volume of the second projecting portion 6. And the openings 8 and 9 are provided only in the first projecting portion 5.

According to the above-described configuration, the outer end edge of the first block 3 on the tread surface 13a in the tire width-direction D1 is located on the outer side in the tire width-direction D1 than that of the second block 4, but the apparent volume of the first projecting portion 5 is larger than the apparent volume of the second projecting portion 6. Accordingly, traction performance is effectively exhibited by the positional relation (uneven shape, for example) of the projecting portions 5 and 6 and the blocks 3 and 4 in the tire width-direction D1 is effectively suppressed.

Further, since the apparent volumes of the first projecting portion 5 and the second projecting portion 6 are different from each other, the traction performance is exhibited by the positional relation (uneven shape, for example) of the first projecting portion 5 and the second projecting portion 6. The apparent volume of the first projecting portion 5 is larger than the apparent volume of the second projecting portion 6, but the openings 8 and 9 are provided only in the first projecting portion 5 having the larger apparent volume. Accordingly, it is possible to effectively suppress the unevenness of the weight balance which may be caused by the difference between the apparent volumes of the first projecting portion 5 and the second projecting portion 6.

The pneumatic tire is not limited to the configuration of the embodiment described above, and the effects are not limited to those described above. It goes without saying that the pneumatic tire can be variously modified without departing from the scope of the subject matter of the present invention. For example, the constituents, methods, and the like of various modified examples described below may be arbitrarily selected and employed as the constituents, methods, and the like of the embodiments described above, as a matter of course.

The pneumatic tire 1 of the embodiment has such a configuration that the openings 8 and 9 are separated from the both end edges of the projecting portion 5 in the tire radial-direction D2 and the tire circumferential-direction D3. However, the pneumatic tire is not limited to this configuration. For example, it is also possible to employ such a configuration that the openings 8 and 9 are separated only from one of end edges of the projecting portion 5 in the tire radial-direction D2, or the openings 8 and 9 may be separated only from one of the end edges of the projecting portion 5 in the tire circumferential-direction D3.

In the pneumatic tire 1 of the embodiment, the projecting amount of the first projecting portion 5 in the tire width-direction D1 is larger than the projecting amount of the second projecting portion 6 in the tire width-direction D1. However, the pneumatic tire is not limited to this configuration. For example, the projecting amount of the first projecting portion 5 in the tire width-direction D1 may be equal to or smaller than the projecting amount of the second projecting portion 6 in the tire width-direction D1.

The pneumatic tire 1 of the embodiment has such a configuration that the apparent volume (volume including openings 8 and 9) of the first projecting portion 5 is larger than the apparent volume of the of the second projecting portion 6. However, the pneumatic tire is not limited to this configuration. For example, the apparent volume of the first projecting portion 5 may be smaller than the apparent volume of the second projecting portion 6.

The pneumatic tire 1 of the embodiment has such a configuration that the actual volume (volume not including openings 8 and 9) of the first projecting portion 5 is larger than the apparent volume of the of the second projecting portion 6. However, the pneumatic tire is not limited to this configuration. For example, the actual volume of the first projecting portion 5 may be smaller than the actual volume of the second projecting portion 6.

Due to the existence of the recess 4a, the actual volume of the first block 3 is larger than the actual volume of the second block 4. It is also possible to employ such a configuration that the projecting amount of the first projecting portion 5 in the tire width-direction D1 is larger than the projecting amount of the second projecting portion 6 in the tire width-direction D1, but the actual volume of the first projecting portion 5 is smaller than the actual volume of the second projecting portion 6. It is also possible to employ such a configuration that the apparent volume of the first projecting portion 5 is larger than the apparent volume of the second projecting portion 6, but the actual volume of the first projecting portion 5 is smaller than the actual volume of the second projecting portion 6.

According to the above-described configuration, the traction performance is effectively exhibited by the positional relation (uneven shape, for example) of the projecting portions 5 and 6 and the blocks 3 and 4 in the tire width-direction D1. It is also possible to suppress the unevenness of the weight balance in the tire circumferential-direction caused by the difference in the actual volumes of the first block 3 and the second block 4 due to the relation between the projecting amounts of the projecting portions 5 and 6 (or actual volumes of projecting portions 5 and 6) and the actual volumes of the blocks 3 and 4.

The pneumatic tire 1 of the embodiment includes not only the first projecting portion 5 but also the second projecting portion 6. However, the pneumatic tire is not limited to this configuration. For example, the pneumatic tire may include only the first projecting portion 5 and may not include the second projecting portion 6.

The pneumatic tire 1 of the embodiment has such a configuration that the first block 3 is not provided at its outer end in the tire width-direction D1 with the recess. However, the pneumatic tire is not limited to this configuration. For example, the first block 3 may be provided at its the outer end in the tire width-direction D1 with a recess which is recessed with respect to the profile surface S2 only if the outer end edge of the second block 4 on the tread surface 13a in the tire width-direction D1 is located on the inner side in the tire width-direction D1 than the outer end edge of the first block 3 on the tread surface 13a in the tire width-direction D1.

The pneumatic tire 1 of the embodiment has such a configuration that the second projecting portion 6 does not have the opening. However, the pneumatic tire is not limited to this configuration. For example, the second projecting portion 6 may include the opening.

The pneumatic tire 1 of the embodiment has such a configuration that the openings 8 and 9 are provided in ½ of the plurality of projecting portions 5 and 6 (i.e., only first projecting portion 5). However, the pneumatic tire is not limited to this configuration. For example, the openings 8 and 9 may be provided only in one of the plurality of projecting portions 5 and 6. It is preferable that the openings 8 and 9 are provided at least in ¼ of the plurality of projecting portions 5 and 6, it is more preferable that the projecting portions 5 and 6 are provided at least in ⅓, and it is further more preferable that the projecting portions 5 and 6 are provided at least in ½.

The pneumatic tire 1 of the embodiment has such a configuration that all of the first projecting portions 5 have the same shapes and all of the second projecting portions 6 have the same shapes. However, the pneumatic tire is not limited to this configuration. For example, the first projecting portions 5 may have a plurality of different shapes, and they may be placed in sequence in the tire circumferential-direction D3. The second projecting portions 6 may have a plurality of different shapes, and they may be placed in sequence in the tire circumferential-direction D3.

The pneumatic tire 1 of the embodiment has such a configuration that the two openings 8 and 9 are provided in every one of the projecting portions 5. However, the pneumatic tire is not limited to this configuration. For example, one or three or more openings may be provided in every one of the projecting portions 5.

In the pneumatic tire 1 of the embodiment, the projecting portions 5 and 6 may be provided at least one of the pair of sidewall portions 12. For example, it is only necessary that the projecting portions 5 and 6 are provided at least in one of the sidewall portions 12 which is placed on the outer side when the pneumatic tire 1 is provided on the vehicle.

In the pneumatic tire 1, the projecting portions 5 and 6 are provided on both of the pair of sidewall portions 12, but the openings 8 and 9 may be provided in the projecting portion 5 of one of or both of the one sidewall portions 12. For example, the openings 8 and 9 may be provided at least in the projecting portion 5 of one of the sidewall portions 12 which is placed on the outer side when the pneumatic tire is mounted on the vehicle.

What is claimed is:

1. A pneumatic tire comprising:
a sidewall portion extending in a tire radial-direction; and
a tread portion having a tread surface on outer side in the tire radial-direction and connected to an outer end of the sidewall portion in the tire radial-direction, wherein
the tread portion includes a plurality of grooves extending to an outer end in a tire width-direction, and a plurality of blocks arranged in a tire circumferential-direction by being defined the blocks by the plurality of grooves,
the plurality of blocks includes a plurality of first blocks and a plurality of second blocks, outer end edges of the second blocks on the tread surface in the tire width-direction being located on an inner side in the tire width-direction than outer end edges of the first blocks on the tread surface in the tire width-direction due to recesses provided at outer ends of the second blocks in the tire width-direction,
the sidewall portion includes a plurality of projecting portions projecting in the tire width-direction,
the projecting portions are placed such that at least portions of the projecting portions are superposed on the first block in the tire radial-direction as viewed in the tire width-direction,
at least one of the projecting portions includes an opening, and
the opening is placed in a portion of the projecting portion which most projects in the tire width-direction.

2. The pneumatic tire according to claim 1, wherein an outer end edge of the opening in the tire radial-direction is located on the outer side in the tire radial-direction than an inner end edge of the recess in the tire radial-direction.

3. The pneumatic tire according to claim 1, wherein the opening is separated from both end edges of the projecting portion in the tire radial-direction and the tire circumferential-direction.

4. The pneumatic tire according to claim 1, wherein the plurality of projecting portions include a plurality of first projecting portions, at least portions of the first projecting portions are superposed on the first block in the tire radial-direction as viewed in the tire width-direction, and the plurality of projecting portions also include a plurality of second projecting portions, and at least portions of the second projecting portions are superposed on the second block in the tire radial-direction as viewed in the tire width-direction.

5. The pneumatic tire according to claim 4, wherein a projecting amount of the first projecting portion in the tire width-direction is larger than a projecting amount of the second projecting portion in the tire width-direction, and
the opening is provided only in the first projecting portion.

6. The pneumatic tire according to claim 4, wherein an apparent volume of the first projecting portion is larger than an apparent volume of the second projecting portion, and
the opening is provided only in the first projecting portion.

7. The pneumatic tire according to claim 5, wherein a maximum projecting amount of the first projecting portion in the tire width-direction is in a range of 120% to 750% of a maximum projecting amount of the second projecting portion in the tire width-direction.

8. The pneumatic tire according to claim 7, wherein a maximum projecting amount of the first projecting portion in the tire width-direction is in a range of 120% to 250% of a maximum projecting amount of the second projecting portion in the tire width-direction.

9. The pneumatic tire according to claim 5, wherein a maximum projecting amount of the first projecting portion in the tire width-direction is in a range of 5 mm to 15 mm, and
a maximum projecting amount of the second projecting portion in the tire width-direction is in a range of 2 mm to 12 mm.

10. The pneumatic tire according to claim 9, wherein a maximum projecting amount of the first projecting portion in the tire width-direction is in a range of 8 mm to 12 mm, and
a maximum projecting amount of the second projecting portion in the tire width-direction is in a range of 5 mm to 9 mm.

11. The pneumatic tire according to claim 4, wherein an outer end of the first projecting portion in the tire radial-direction is located on an inner side in the tire radial-direction than the tread surface of the first block.

12. The pneumatic tire according to claim 4, wherein an outer end of the second projecting portion in the tire radial-direction is located at the same position as a bottom surface of the recess of the second block in the tire radial-direction.

13. The pneumatic tire according to claim 1, wherein the first blocks and the second blocks are alternately placed in the tire circumferential-direction.

14. The pneumatic tire according to claim 1, wherein at least one of the projecting portions includes the two openings,
the sidewall portion includes an annular protrusion portion projecting in the tire width-direction and extending along the tire circumferential-direction,
the first opening is placed on an inner side in the tire radial-direction than the annular protrusion portion, and
the second opening is placed on an outer side in the tire radial-direction than the annular protrusion portion.

15. The pneumatic tire according to claim 1, wherein the projecting portion is placed such that 25% or more of the projecting portion in the tire circumferential-direction is superposed on the first block in the tire radial-direction as viewed in the tire width-direction.

16. The pneumatic tire according to claim 1, wherein a width size between an opening edge of the opening and an end edge of the projecting portion is 1.5 mm or more.

17. The pneumatic tire according to claim 1, wherein a center position of the opening in the tire circumferential-direction matches with a center position of the projecting portion in the tire circumferential-direction.
